(19) United States
(12) Patent Application Publication
(10) Pub. No.: US 2016/0215962 A1
(43) Pub. Date: Jul. 28, 2016

(54) LED Bulb or LED Night Light Has Moving Project-Image

(71) Applicant: Tseng-Lu Chien, Walnut, CA (US)

(72) Inventor: Tseng-Lu Chien, Walnut, CA (US)

(21) Appl. No.: 14/983,993

(22) Filed: Dec. 30, 2015

Related U.S. Application Data
(63) Continuation-in-part of application No. 14/289,968, filed on May 29, 2014.
Application No. 14/289,968 is a continuation-in-part of application No. 14/280,865, filed on May 19, 2014.
Application No. 14/280,865 is a continuation of application No. 13/540,728, filed on Jul. 3, 2012, now Pat. No. 8,834,009.
Application No. 13/540,728 is a continuation-in-part of application No. 14/503,647, filed on Oct. 1, 2014.
Application No. 14/503,647 is a continuation-in-part of application No. 14/323,318, filed on Jul. 3, 2014.

(51) Int. Cl. F21V 14/08; F21V 14/02; F21S 10/02; F21S 8/00; F21V 23/00; F21K 99/00; F21V 14/06; F21V 5/04

(52) U.S. Cl. CPC F21V 14/08; F21V 14/06; F21V 14/02; F21V 5/04; F21S 8/035; F21V 23/003; F21K 9/58; F21S 10/02; F21Y 2101/02; F21Y 2113/002

(57) ABSTRACT

The LED light device including LED night light or LED Bulb has the moving project image by (1) LEDs on time difference period (2) magnetic field force to making film/opening/printed piece moving (3) motor or movement to make the film/opening/printed piece or project-lens moving. All big image created from LED light source through film/opening/printed piece/slide then through the project lens to make the lighted tiny image to passing though refraction properties project len(s) to get the bigger size or colorful or steady or moving bigger image for wider viewing angle to viewer. The said moving image effect created by make the said film/slide/openings/printed piece or-and the said project len(s) to make moving, shaking, spin, rotating, vibration to get the desired moving effect(s).

### RELATED U.S. APPLICATION DATA

This filing is Division filing of (# QQQ-2) U.S. application Ser. No. 14/289,968 filed on ______, which is Division filing of (# QQQ-1) of U.S. application Ser. No. 14/280,865, filed on May 10, 2014 and is Continue of (# QQQ-12) U.S. Ser. No. 13/540,728 LED Bulb now is allowanced and issue fee paid before May 19, 2014 Now is U.S. Pat. No. 8,834,009. Related for LED bulb has project or-and night light.

This filing is Division filing of (# ZZZ-3) U.S. application Ser. No. 14/503,647 filed on ______ which is Division filing of (# ZZZ-2) U.S. application Ser. No. 14/451,822 filed on ______, which is Continue In Part filing of (# ZZZ-1) U.S. application Ser. No. 14/323,318 filed on ______ which is Continue In Part filing of (# ZZZ-13) U.S. application Ser. No. 14/023,889 filed on ______. Related to the wider area image or project image night light with or without motor/spin/rotating kits for moving image.

This filing is Division filing of (# MMM-1) U.S. application Ser. No. 14/606,242 filed on ______ now is which is Continue in Part of (# MMM-11) U.S. application Ser. No. 13/367,758 filed on ______, Now is U.S. Pat. No. 8,967,831. Related for the LED Bulb has extendable/retractable design to overcome block-items to interfer the camera, electric signal delivery.

This filing is Division filing of (# JJJ-1) U.S. application Ser. No. 14/049,427 now is U.S. Pat. No. 9,010,986 Apr. 21, 2015 issued, which is continue filing of (# JJJ-11) U.S. application Ser. No. 13/296,508 Filed on ______. Now is U.S. Pat. No. 8,562,158 issued on Oct. 22, 2013. Related the LED bulb has built-in Camera and storage-kits with multiple functions to replay, see by wired or wireless.

This is Division filing for (# AAA-1) ______, (# AAA) U.S. application Ser. No. 12/984,583,

This is Division filing for (#TT-2) U.S. application Ser. No. 14/967,250, (# TT-1) ______, (# TT-12) U.S. application Ser. No. 12/866,832,

This is Division filing for (FF-4) U.S. application Ser. No. 14/968,862, (FF-3) U.S. application Ser. No. 14/539,267, (FF-2) U.S. application Ser. No. 14/275,184, (#FF-1) U.S. Pat. No. 8,721,160,

This is Division filing for (DD-5) U.S. application Ser. No. 14/968,153 for LED light has projection features.

### DESCRIPTION

This filing is Division filing of (# QQQ-2) U.S. application Ser. No. 14/289,968 filed on ______, which is Division filing of (# QQQ-1) of U.S. application Ser. No. 14/280,865, filed on May 10, 2014 and is Continue of (# QQQ-12) U.S. Ser. No. 13/540,728 LED Bulb now is allowanced and issue fee paid before May 19, 2014 Now is U.S. Pat. No. 8,834,009. Related for LED bulb has project or-and night light.

This filing is Division filing of (# ZZZ-3) U.S. application Ser. No. 14/503,647 filed on ______ which is Division filing of (# ZZZ-2) U.S. application Ser. No. 14/451,822 filed on ______, which is Continue In Part filing of (# ZZZ-1) U.S. application Ser. No. 14/323,318 filed on ______ which is Continue In Part filing of (# ZZZ-13) U.S. application Ser. No. 14/023,889 filed on ______. Related to the wider area image or project image night light with or without motor/spin/rotating kits for moving image.

This filing is Division filing of (# MMM-1) U.S. application Ser. No. 14/606,242 filed on ______ now is which is Continue in Part of (# MMM-11) U.S. application Ser. No. 13/367,758 filed on ______, Now is U.S. Pat. No. 8,967,831. Related for the LED Bulb has extendable/retractable design to overcome block-items to interfer the camera, electric signal delivery.

This filing is Division filing of (# JJJ-1) U.S. application Ser. No. 14/049,427 now is U.S. Pat. No. 9,010,986 Apr. 21, 2015 issued, which is continue filing of (# JJJ-11) U.S. application Ser. No. 13/296,508 Filed on ______. Now is U.S. Pat. No. 8,562,158 issued on Oct. 22, 2013. Related the LED bulb has built-in Camera and storage-kits with multiple functions to replay, see by wired or wireless.

This is Division filing for (# AAA-1) ______, (# AAA) U.S. application Ser. No. 12/984,583,

This is Division filing for (#TT-2) U.S. application Ser. No. 14/967,250, (# TT-1) ______, (# TT-12) U.S. application Ser. No. 12/866,832,

This is Division filing for (FF-4) U.S. application Ser. No. 14/968,862, (FF-3) U.S. application Ser. No. 14/539,267, (FF-2) U.S. application Ser. No. 14/275,184, (#FF-1) U.S. Pat. No. 8,721,160,

This is Division filing for (DD-5) U.S. application Ser. No. 14/968,153 for LED light has projection features.

The current invention is Continuously or Division filing for co-pending filing case as below which NOT ONLY for parent filing features including (1) Project light (2) More than one function (3) adjust focus (4) adjust angle (5) Elastic contact points (6) LED heat solution (7) Heat sensitive parts installation (8) extend means BUT ALSO including new features (a) has movable-means to allow the at least one of level of the more than one lever LED bulb can move the desire level(s) away from original position, location, orientation to overcome all the interfere block-means so the said LED bulb can solve the (a) heat issue from LED(s) or circuit or electric components (b) lamp shade metal frame's block out the LED bulb light beam traveling (c) glass or metal or cement block means to block out the electric signals transmit from Bluetooth means, wifi means, internet means, App software means or any other electric wave-signals transmitting to control the said LED bub and its related electric parts or accessories. It is appreciated all the above listed or discussed co-pending or issued patents co-inventor's concept, idea, design still should be consider within the current inventon's scope and fall within the current invention's claims.

Furthermore, the current invention has the moving Big project-image light performance to be seen on wider viewing angle which can created by (aa) making the said LEDs has different time to turn on and off to make light source changing portion related to the film/openings/project lens, or-and (ab) making rotating, spin, vibration, shake, moving of the said film/openings/slide/printed piece, or-and project-lens has refractive optics properties, so can make the big projection image has desired moving effects. The current invention with moving or steady big projection image still fall within the basic relative position for parts such as LED light source to Film/openings/slide/printed piece (image carrier) to project-lens which has refraction properties and all these LED/Image carrier/project lens can fit into tube, tube assembly, frame, holder, disc, groove, ditch of the separated piece(s) or of the said housing parts including but not limited for Night light or LED bulb.

Hereafter disclosure all below listed co-pending and patented as prior arts still fall within the current invention as below:

U.S. Ser. No. 13/367,758, U.S. Ser. No. 13/367,687, U.S. Ser. No. 13/296,508, U.S. Ser. No. 13/295,301, U.S. Ser. No. 13/021,107, U.S. Ser. No. 12/950,017, U.S. Ser. No. 12/938,564, U.S. Ser. No. 12/886,832, U.S. Ser. No. 12/876,507, U.S. Ser. No. 12/771,003, U.S. Ser. No. 13/021,124, U.S. Ser. No. 12/624,621, U.S. Ser. No. 12/622,000, U.S. Ser. No. 12/318,470, U.S. Ser. No. 12/914,584, U.S. Ser. No. 12/834,435, U.S. Ser. No. 12/292,153. U.S. Ser. No. 12/907,443, U.S. Ser. No. 12/232,505, U.S. Ser. No. 11/806,711, U.S. Ser. No. 11/806,285.

The current invention is Continue filing for Ser. No. 13/295,301 “The Device has build-in Digital Data means and Powered by unlimited power source of light device”.

The current invention is Continue filing for Ser. No. 13/296,508 “The Device has build-in Digital Data means and power unlimited power source of LED Bulb”

The current invention is continuously filing for Ser. No. 13/296,460 “The device has build-in Digital data means and powered by unlimited power source of Lamp Holder.

These (3) co-pending filing are Continuously filing of Ser. No. 12/951,501 “Lamp Holder has build-in LED Night light”

The current invention is continuously filing for Ser. No. 12/950,017 “Multiple surface LED light”

All these are Continuously filing for Ser. Nos. 13/296,508, 13/295,301, 13/296,469 are continuously filing for Ser. No. 13/162,824 Light device with display means has track-means and removable LED-unit(s) which are the continuously filing for Ser. No. 12/938,628 LED light fixture has outlet(s) and removable LED unit(s) and for Ser. No. 12/887,700 Light fixture with self-power removable LED unit(s). Those are continuously filing for Ser. No. 12/149,963 (Now U.S. Pat. No. 7,722,230), Ser. No. 12/073,095 (Now U.S. Pat. No. 7,726,869), Ser. No. 12/073,889 (Co-Pending Filing), Ser. No. 12/007,076 (Now U.S. Pat. No. 7,726,841), Ser. No. 12/003,691 (Now U.S. Pat. No. 7,726,839), Ser. No. 12/894,865 (Co-Pending Filing).

This is continuation of U.S. patent application Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11/527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156. 11/094,155. 10/954,189, 10/902,123, 10/883,719, 10/883,747, 10/341,519, 12/545,992, 12/292,580, 12/710,918, 12/624,621, 12/622,000, 12/318,471, 12/318,470, 12/318,473, 12/292,153, 12/710,561, 12/710,918, 12/711,456, 12/771,003

This is Division of U.S. patent application Ser No. 13/______ field on Nov. 11, 2011 for The Device has build-in digital data means and powered by unlimited power source for Lamp Holder.

This is Division of U.S. patent application Ser. No. 13/______ field on Nov. 11, 2011 for The Device has build-in digital data means and powered by unlimited power source for light Device.

This is continuously of U.S. patent application Ser. No. 12/951,501 field on Nov. 20, 2010 for Lamp Holder has build-in LED light.

This is continuously of U.S. patent application Ser. No. 12/771,003 field on Apr. 29, 2010 for LED light has geometric-unit 9s) incorporated project means.

This is continuously of U.S. patent application Ser. No. 12/711,456 Field on Feb. 25, 2010 for LED power failure Light

This is continuously of U.S. patent application Ser. No. 12/710,561 Field on Feb. 25, 2010 for LED light device has special effects

This is continuously filing of U.S. patent application Ser. No. 12/710,918 Field on Feb. 25, 2010 for LED light device has more than 1 reflective means for plurality of image

This is continuation of U.S. patent application Ser. No. 12/624,621 Field on Nov. 24, 2009 file for the “project device or assembly for variety of LED light”

This is continuation of U.S. patent application Ser. No. 12/622,000 Field on Nov. 24, 2009 file for the “Interchangeable Universal Kits for all LED light”

This is continuation of U.S. patent application Ser. No. 12/318,471 Field Dec. 30, 2008 file for the “LED night light with pinhole imaging”

This is continuation of U.S. patent application Ser. No. 12/318,470 Field Dec. 24, 2008 file for the “LED night light with Projection features”

This is continuation of U.S. patent application Ser. No. 12/318,473 Field Dec. 8, 2008 file for the “LED night light with laser or hologram element”

This is continuation of U.S. patent application Ser. No. 12/292,153 Field Nov. 8, 2008 file for the “LED night light with Projection or imaging features”

This is continuation of U.S. patent application Ser. No. 12/232,505 Field Sep. 16, 2008 file for the “LED night light with Projection features”

This is continuation of U.S. patent application Ser. No. 12/149,963 Filed on Apr. 21, 2008 file for the “Removable LED light device.

This is continuation of U.S. patent application Ser. No. 12/149,964 Filed on Apr. 21, 2008 file for the “Surface Mounted Device with LED light”.

This is continuation of U.S. patent application Ser. No. 12/073,095 Filed on Feb. 29, 2008 file for the “LED Track light device.

This is Continuation of U.S. patent application Ser. No. 12/073,889, filed on Feb. 12, 2008 file for the “LED light with changeable position with Preferable power source”.

This is Continuation of U.S. patent application Ser. No. 12/007,076, filed on Jan. 7, 2008 file for the “LED light with changeable geometric system”

This is Continuation of U.S. patent application which the Ser. No. 12/003,691, filed on Dec. 31, 2007 file for the “LED light with changeable geometric dimension features”

This is Continuation of U.S. patent application which the Ser. No. 12/003,809, filed on Jan. 2, 2008 file for the “LED light with changeable features”

This is Continuation of U.S. patent application which the Ser. No. 11/806,711 filed on Apr. 30, 2007 file for the “Multiple LED light with adjustable angle features”

This application is continuation of U.S. patent application Ser. No. 11/806,285. LED Night light with outlet device filed on Apr. 30, 2007

This application is continuation of U.S. patent application Ser. No. 11/806,284 LED Night light with more than 1 optics means filed on Apr. 28, 2007

This application is continuation of U.S. patent application Ser. No. 11/527,628. Multiple function Night light with air fresher filed on Sep. 27, 2006.

This application is continuation of U.S. patent application Ser. No. 11/527,629. LED Night light with interchangeable display unit filed on Sep. 27, 2006.

This application is continuation of U.S. patent application Ser. No. 11/498,874. Area illumination Night light filed on Aug. 4, 2006.

This application is continuation of U.S. patent application Ser. No. 11/527,631. LED Time piece night light field on Sep. 27, 2006.

This application is continuation of U.S. patent application Ser. No. 12/545,992 LED time piece Night light filed division of Ser. No. 11/527,631 on Aug. 24, 2009.

This application is continuation of U.S. patent application Ser. No. 12/292,580 LED Time Piece Night light filed division of Ser. No. 11/527,631 on Aug. 24, 2009.

This application is continuation of U.S. patent application Ser. No. 11/498,881, Poly Night light filed on Aug. 4, 2006.

This application is continuation of U.S. patent application Ser. No. 11/255,981, Multiple light source Night Light filed on Oct. 24, 2005.

This application is continuation of U.S. patent application Ser. No. 11/184,771 Light Device with EL elements field on Oct. 11, 2005

This application is continuation of U.S. patent application Ser. No. 11/1152,063 Outlet adaptor with EL field on Jun. 5, 2005

This application is continuation of U.S. patent application Ser. No. 11/094,215 LED night light with liquid medium filed on Mar. 31, 2005

This application is continuation of U.S. patent application Ser. No. 11/094,215, filed Mar. 30, 2005 LED Night light with Liquid optics medium.

This application is continuation of U.S. patent application Ser. No. 11/092,741, filed Mar. 30, 2005 Night light with fiber opotics.

This application is continuation of U.S. patent application Ser. No. 10/883,747, filed Jul. 6, 2004 Fiber Optic light kits for footwear.

This application is continuation of U.S. patent application Ser. No. 11/498,874, Area Illumination for LED night light

This application is continuation of U.S. patent application Ser. No. 11/527,629. Time Piece with LED night light,

This application is continuation of U.S. patent application Ser. No. 11/527,628. Multiple Function Night light with Air Freshener

This application is continuation of U.S. patent application Ser. No. 11/806,284 LED Night light with more than one optics mediums

This application is continuation of U.S. patent application Ser. No. 11/806,285 LED Night Light with multiple functions

This application is continuation of U.S. patent application Ser. No. 11/806,711 Multiple LEDs Light with adjustable angle function

The current invention incorporate with above listed co-pending or patented cases' features, construction still fall within the current inventions scope and all related equivalent function or replace parts also should fall within the current invention.

### BACKGROUND

The current invention for LED bulb or night light has at least one movable parts to make the at least one of the said image carrier or-and project-len(s) of the said LED night light or LED Bulb can has the big project image show the moving effects including to let the group of LED(s) turn on and turn off on different time period to make the light source to change the position, location, orientation with related image carrier or-and project-lens to look like moving effects to make desire light functions, performance, effect.

The at least one of the LED(s) or-and image-carrier(s) or-and project-lens incorporate with movable-device including but not limited from IC chip, motor, clock movement, magnetic and magnetic coil set, so can get the moving effects for big project image on desired surface which at least arms distance away from the LED night light or LED bulb.

The current invention for LED night light as the co-pending filing

This filing is Division filing of (# ZZZ-3) U.S. application Ser. No. 14/503,647 filed on ______ which is Division filing of (# ZZZ-2) U.S. application Ser. No. 14/451,822 filed on ______, which is Continue In Part filing of (# ZZZ-1) U.S. application Ser. No. 14/323,318 filed on ______ which is Continue In Part filing of (# ZZZ-13) U.S. application Ser. No. 14/023,889 filed on ______. Related to the wider area image or project image night light with or without motor/spin/rotating kits for moving image and these co-pending filing has teach to apply the motor or time piece movement or magnetic & magnetic-coil set to make the said image-carrier to be shake, vibration, spin, rotating, moving so can get the big project image has moving effects to see like Aurora, water wave effects like (#ZZZ-3) Ser. No. 14/503,647 and (#ZZZ-2) Ser. No. 14/451,822. Also, by other multiple optics-lens has reflection or-and refraction properties assembly to make the splendid big project images such as (#ZZZ-13) Ser. No. 14/023,889 and (#ZZZ-1) Ser. No. 14/323,318.

The current invention for LED bulb as the co-pending filing

This filing is Division filing of (# QQQ-2) U.S. application Ser. No. 14/289,968 filed on ______, which is Division filing of (# QQQ-1) of U.S. application Ser. No. 14/280,865, filed on May 10, 2014 and is Continue of (# QQQ-12) U.S. Ser. No. 13/540,728 LED Bulb now is allowanced and issue fee paid before May 19, 2014 Now is U.S. Pat. No. 8,834,009. Related for LED bulb has project or-and night light. The co-pending filing cover all kind of Single or multiple projection bulb with adjustable focus, projection direction or angle and incorporated co-pending (# AAA) (#TT) (#FF) (#DD) (#CC) projection night light all major parts & accessories to created changeable slide, multiple image, multiple project head or manual or auto moving slide of the said disc. Same for the concept of these LED night light of the co-inventor's co-pending filing to apply to the same theory and same concept major kits including but not limited for LED+ image carrier+Project lens into the said market available Bulb housing with Bulb base with the one more twist-tight bulb base electric contactor will become the current inventions LED project Bulb with variety construction including has overcome block-means as co-pending (#QQQ-2) Ser. No. 14/289,968.

From the co-pending all projection theory discussed or listed above, the current invention further disclosure the one project night light or LED bulb has built-in multiple project-assembly like the co-inventor's U.S. Pat. No. 8,083,377 issued date Dec. 27, 2011 FIG. 15 and FIG. 16 has the multiple project head to create multiple big project images on areas or surface. The current invention also had same concept to have multiple LEDs+ image carries+project-lens with the motor/time piece movement/rotate kit/spin kit/movement means/magnetic & magnectic-coil set/IC with parts to make the light source or-and image carriers or-and project-lens to make moving effects to viewers.

The current said Night light is cover all the plug-into Outlet night light or desktop night light which has the housing parts, tube, tube assembly like U.S. Pat. No. 8,083,377 FIG. 4 to install the said image carriers or-and project lens or other parts including but not limited such as other optics lens, motor, gear set, time piece movement with desired speed for spin, or-and holder, frame, disc to hold the said optics-lens, project lens, tube piece, LEDs, image carrier or carriers with desired focus with adjustable kits to variable requirement for different distance for Big Image surface.

The current invention of LED bulb same as above discussed night light has any number of the multiple tube or tube-assembly or-and LEDs or-and project-lens assembly to put all parts inside the existing marketing similar bulb shape housing. The said major 3 parts LEDs, image carrier, project lens fit within the said tube, tube assembly, housing parts of LED bulb or LED night light. As long as the arrangement same as LED—Image carrier—Project Lens all should be fall within the current invention with moving device including the (1) LED on time different time (2) Motor/movement/spin/rotate device to move the image carrier or-and project-lens. The LED bulb can use for all desk lamp or down light or recess light lamp holder or some adaptor with preferred power switch or auto sensor switch and all co-pending filing features including:

The current invention co-pending (# QQQ-2) U.S. application Ser. No. 14/289,968 teach LED bulb also good for LED Bulb for upper or down installation because has including extractable means, extendable means which can overcome the down light application because some down light (LED Bulb base face sky) has lamp shade which made of glass, metal, cement, concrete surrounding the said Down light or recess light installation so these electric-signal block-means will affect, interfere the electric signal transmitting so let Bluetooth control, Wifi control, remote control, infra-red control, internet control, App software control loose or reduce or limited the signal transmitting to let these functions become a problem. So the current invention's co-pending (# QQQ-2) U.S. application Ser. No. 14/289,968 teach all proper movable-means help to overcome these electric signal block means and make the LED bulb has its designed and pre-determined functions without any affect or interfere or limited by the said electric-signal block-means.

The current invention's co-pending (# QQQ-2) U.S. application Ser. No. 14/289,968 teach has more than one level(s) (including parts and accessories) LED bulb which each level can has its own functions or multiple functions control by market available skill or method may selected from Blue-tooth, Wifi, internet, App software, IC, Remote signal, infra-red signal, motion sensor, heat sensor though computer, communication, consumer device by people. Such as the more than one levels LED Bulb has (1) Multiple colors with changeable colors and moving effects (2) Multiple functions select from market available any LED light effects for indoor and outdoor lighting (3) Multiple control means which select from market available control, sensor, switch, blue-tooth, wifi, internet, app software, remote, infra-red or other electric or electronic related circuit or device(s) (4) More than one movable-means (5) Changeable geometric shape (6) Changeable construction (7) moveable means select from any group combination from bar, pole, spin, rotate, hinge, arms, joints, join, frame, connector, sections to make the levels, parts, accessories to be move away to desire location, positions. These are the main features of the current invention.

The current invention mainly for LED bulb which has following co-pending US Application many cases also teach other features as parent filing case stated as below:

1. The current invention co-pending U.S. application many cases also teach the said LED Bulb has property that the LED bulb can have more twist degree or twist angle after LED Bulb's contact-Point touched electrode—This features can get horizon more than 360 degree to let the light beam to position the certain area(s) to get more wider of adjust angle and more wider of adjust directions and it also can incorporated with adjustable Focus means to make the same of LED light beams or image to shown different light performance on the desired locations or area(s). The Rotatable LED Ball with two arms to offer the said LED Bulb of preferable Geometric shape and construction, can adjust angle in vertical axis up to more than 360 degree angle so can get the LED Bulb's plurality of light beams can cover all x-y-z axis areas by at least one of light beam or plurality of the light beam to illuminate the near-by or far-away or remote-away or any combination of the said LED Bulb. (Lamp holder co-pending).

2. The current invention co-pending U.S. Application many cases also teach the said LED Bulb has One or more than one of the light beams arrange in LED bulb for desire light performance. As co-pending filing content which has more than one LED light source(s) are for Night light, more than on project assembly for project LED lighting. The current invention can create same light performance as the co-pending or patented applications as attached drawings, the difference than prior-arts with night light because Night light has prong means and for outlets installation and not have extend/retractable means.

3. The current invention co-pending U.S. application many cases also teach the said LED Bulb has Focus adjustable means so can make same light beam emit out from same LED bulb to wherever surface(s) with desired light performance with brightness, size, light spots, color, lit-areas. The same light beam output from same LED Bulb with focus adjustable means can create the different light pattern, light path, light brightness, light performance, light direction, light performance by viewer.

4. The current invention co-pending U.S. application many cases also teach the said LED Bulb has extendable means such as extend tube, telescope tube or equivalent extendable, receivable means which can make the electric parts & accessories etc. of LED bulb keep away from LED(s)'s heat, block-means of lighting's curtain, lighting's shade, lighting's glass, cylinder tube of recess lighting, or other block-means which block the motion-sensor lens, remote control signal, or light beam emit direction. To keep the said LED bulb's related Circuit board/control means/IC means/switch means/sensor means/electric parts or assembly means—Away from the LED-units or block-means to prevent from heat affect the desire functions, performance, such as Motion sensor or PIR sensor head or Fresnel lens or LED-unit light beam emit direction.

5. The current invention co-pending U.S. application many cases also teach the said LED Bulb has Extractable/extendable/movable means to put heat sensitive or light sensitive parts away from LEDs' heat, light's shade, light's curtain, light's glass, decorative material, ceiling block means, or any other block means which will interfere the LED bulb or LED Bulb's related parts & accessories. The said extendable or extractable means preferred to design on front of the LED bulb, but it depend on the different requirement and different consideration of heat, block-means which offer the more space to install the preferred electric parts & accessories, offer the extra length to far-away from heat means or block-means so the LED bulb can overcome heat and block-means for any applications, installation.

6. The current invention co-pending U.S. application many cases also teach the said LED bulb different from all market available LED Bulb which offer The illumination only cover the adjacent area which are start from the LED Bulb to certain distance (illumination surrounding LED Bulb or start from LED bulb to certain distance with illumination) and do not offer the illumination or image to a area(s) which has certain direction(s), angle(s), distance(s) which far away or remote-away from the LED Bulb. The current invention can make any combination to offer the near-by areas illumination, far-away areas illumination or together for both illumination effects.

7. The current invention co-pending U.S. application many cases also teach the said LED Bulb has more than one light beams output to different area(s), direction(s), location(s) and make more than one years with illuminations which all these areas may not adjacent, link, sit together. The said LED bulb may offer more than one area(s) have illumination is other features of current other features which can allow people to make the energy saving and only offer illumination for where needed such as Stair lighting which only Up or Down two direction need illumination to see stairs. Rest areas no need the light at all and the said stair-lighting has Build in Motion Sensor has sensitivity up to 10-30 feet is enough to cover one floor stairs (Normally is 18 steps). One light beam for LED bulb to emit up 9 steps and one light beam of same LED bulb to emit down 9 steps. This will be enough illumination because each UP or DOWN stair are been illuminated by each Floor's one LED Bulb, so 2 different of light beam(s) to offer same one UP or One Down 9 steps . . . . This is pretty good power saving device while motion sensor device build-in more than one of light beam as output from one LED bulb.

Hence, the current invention & co-pending U.S. application many cases also teach LED night light or LED Bulb can has at least one or plurality of light beam output from one LED bulb or night light to near-by area(s), remote-away area(s), far-away area(s) or any combination of these area(s) with adjust angle, adjust focus, elastic contact-point, rotate/spin/tilt frame or support or base to get desire direction to emit light beam, extend/retractable means to install all parts & accessories away from heat or block-means are all belong to current invention features so can let all light beam to emit to area(s) where need the illumination, Not like conventional LED bulb only can supply the near-by area(s) which start from the LED-bulb to certain limited distance areas (LED bulb has limited brightness to emit to long distance except like current invention to apply optics lens or lens assembly to project light beams to remote-away or far-away distance which current market items can not create.)

### DRAWINGS

FIG. 1 and FIG. 2: Disclosure the 1^{st} embodiment of the said project image main construction for LED night light or LED Bulb has LED light source(s), image carrier(s), project-lens(s) to form the big project image on desired location and emit out from the said LED night light or LED bulb.

FIG. 1A and FIG. 1B and FIG. 1C: Disclosure the 3 embodiment of the said project night light has the wider viewing angle moving project image from the said 3 different moving theory night light. FIG. 1A is use LEDs on time on different time period to change the Light source relative position, orientation to the said image carrier or-and project-lens(s). FIG. 2A is used motor or movement, spin, rotate, moving device to make the said image carrier(s) to moving to make the big project image to moving. FIG. 3A use the magnetic & magnetic-coil with mechanical arms to make the image carrier to moving, shaking, swing to make the said big project image moved.

FIG. 1D: Disclosure the FIG. 1B for details construction which has movement or motor on bottom with axis long enough to hold and rotate the said image carrier and also allow the LEDs and circuit board along the axis so can allow LED(s) light beam passing through the top optic-lens (change narrow LED light beam to wider and parallel light beam) to hit the top image-carrier and light passing through the image-carrier's opening, cutout, windows, printed window, film, slide, or display or digital data display and go through the top project-lens which may in variety type including but not limited for one refraction-lens or multiple refraction-lens or refraction with reflection lens or any combinations from market available type to create desired light effects. (This drawing same as co-pending filing (# ZZZ-3) U.S. application Ser. No. 14/503,647),

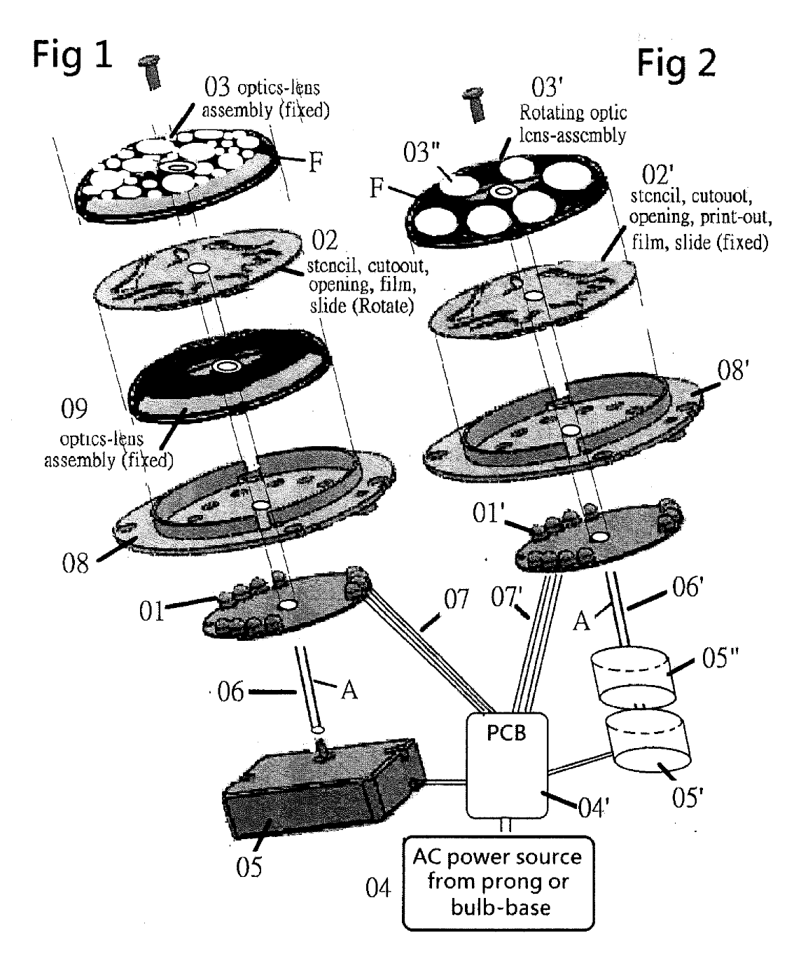

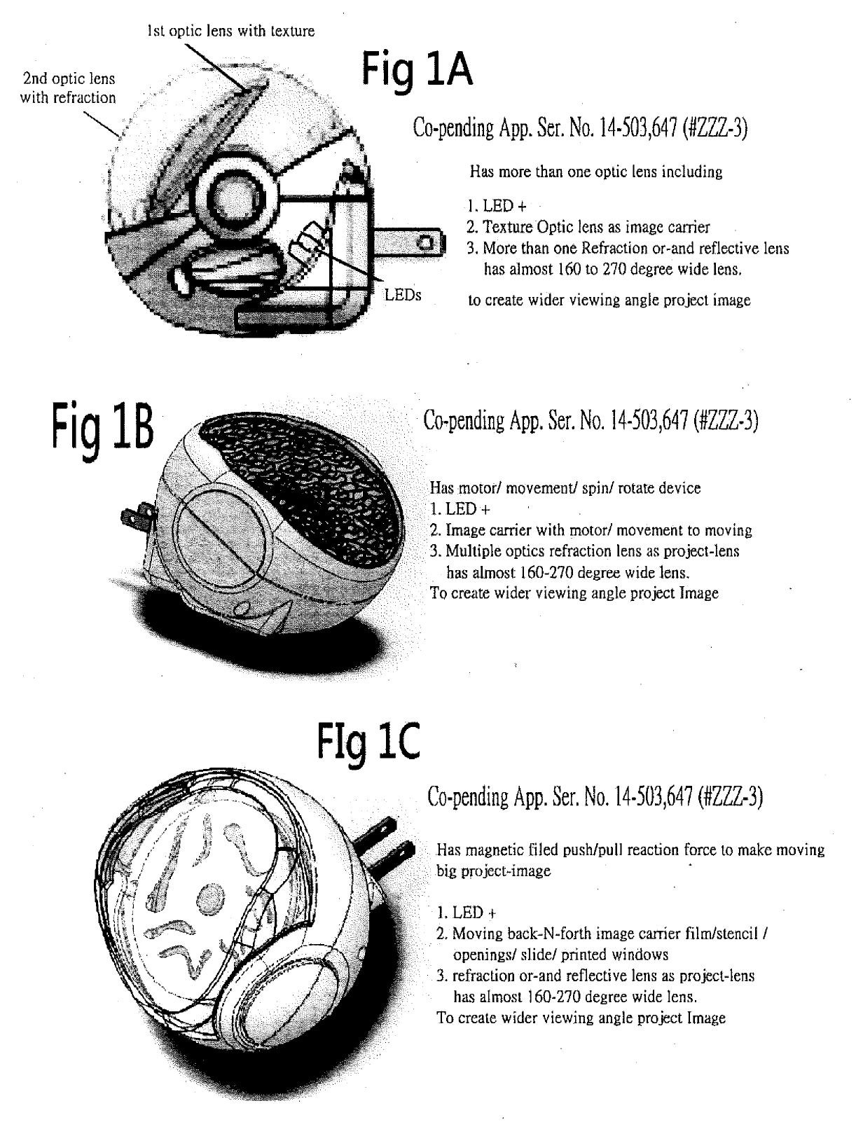

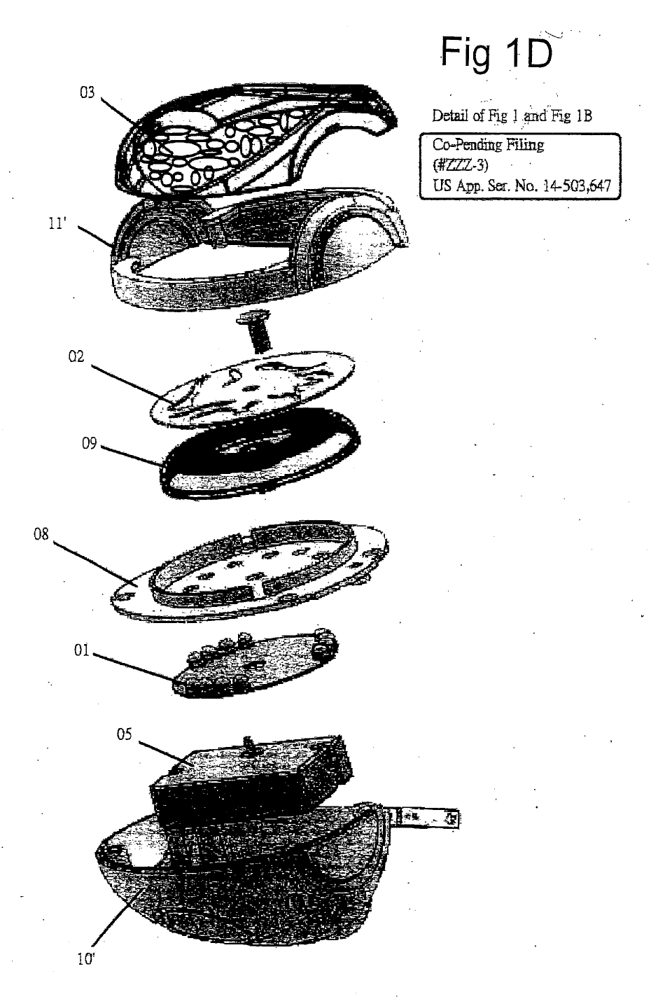

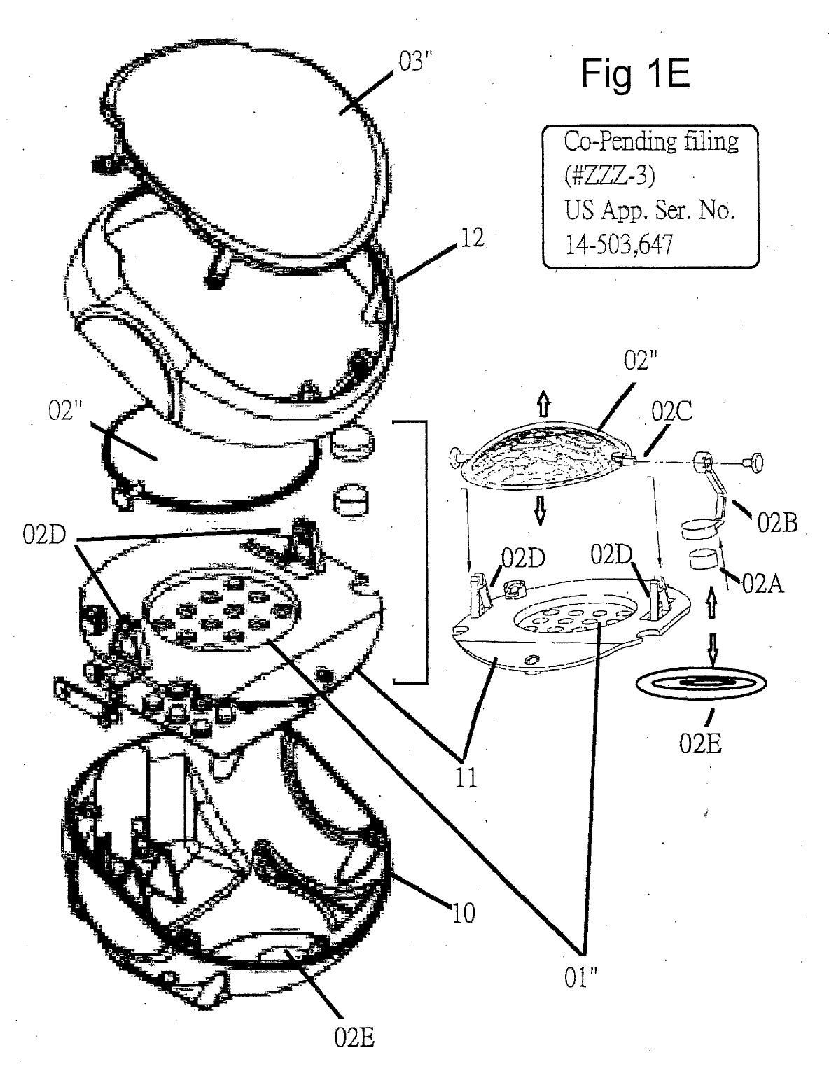

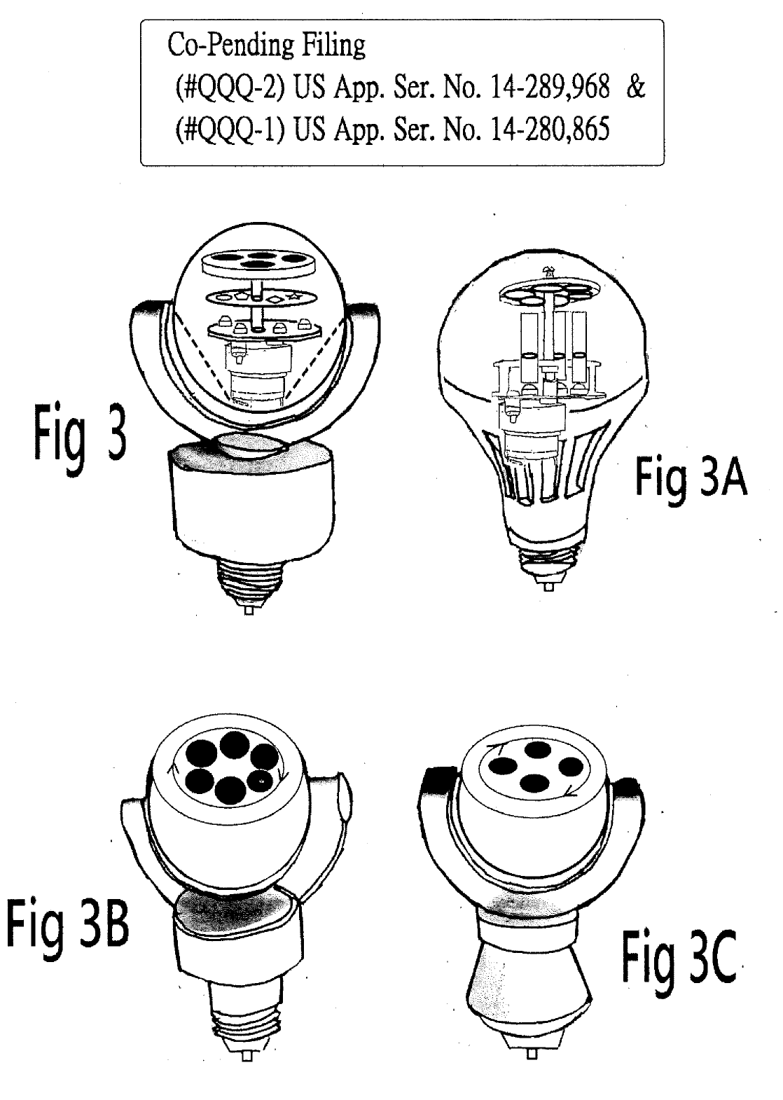

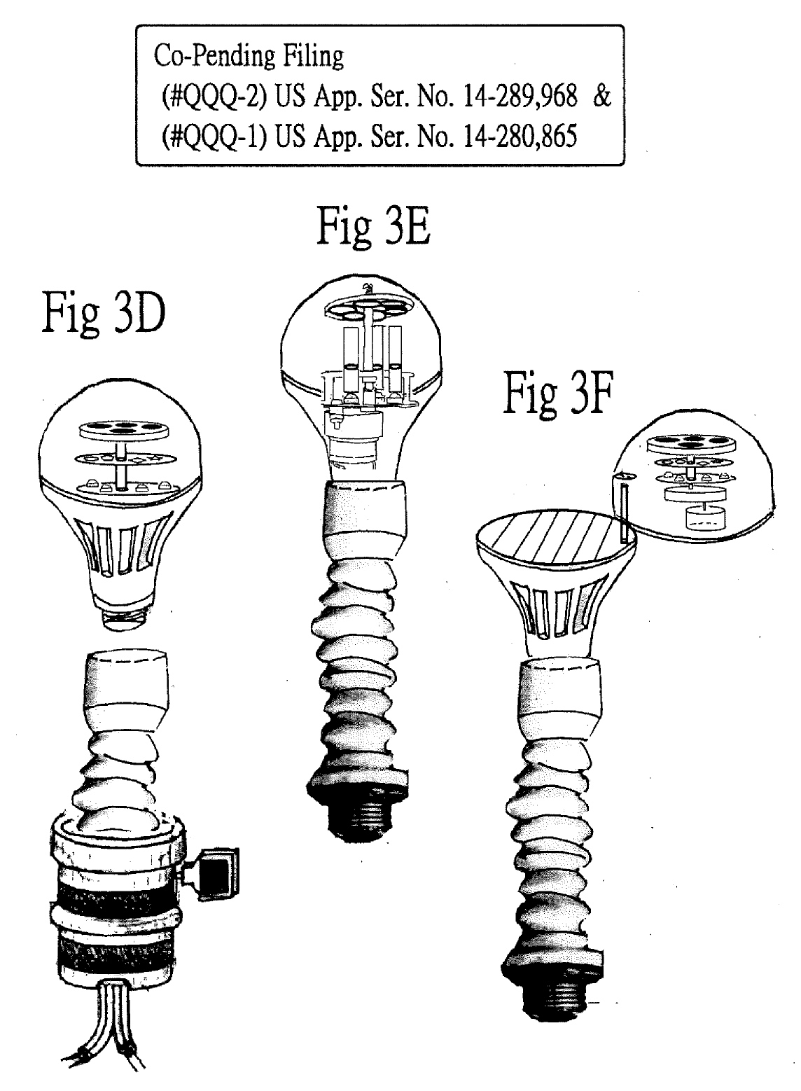

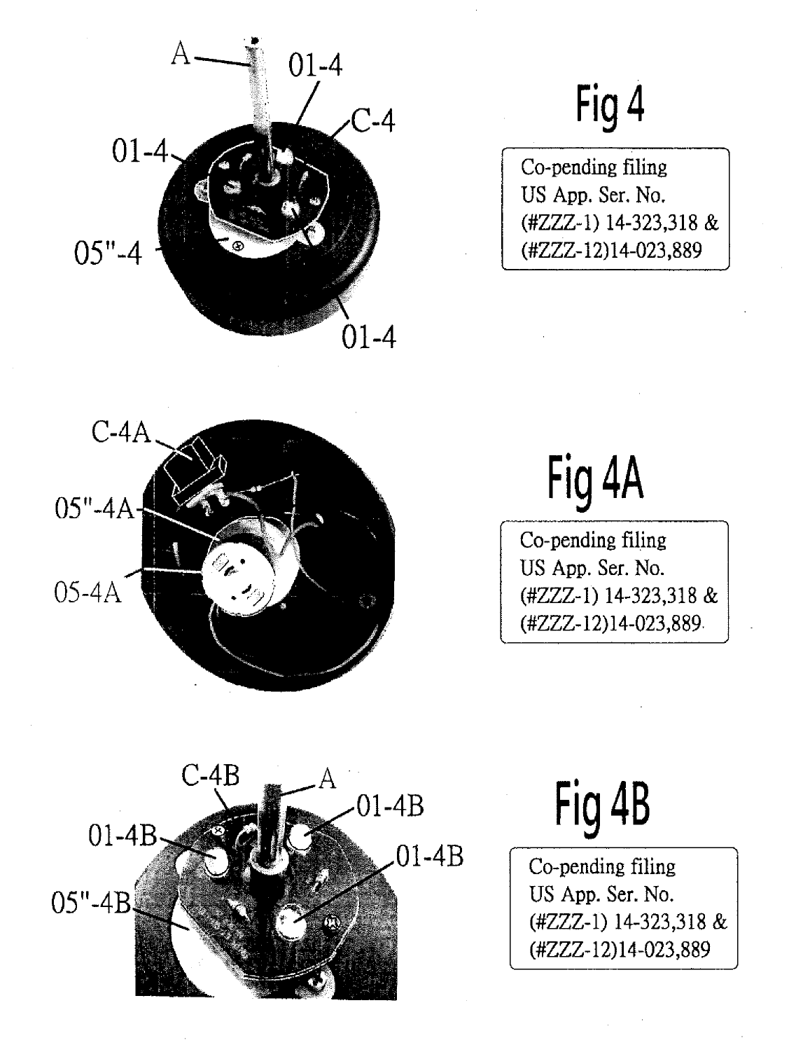

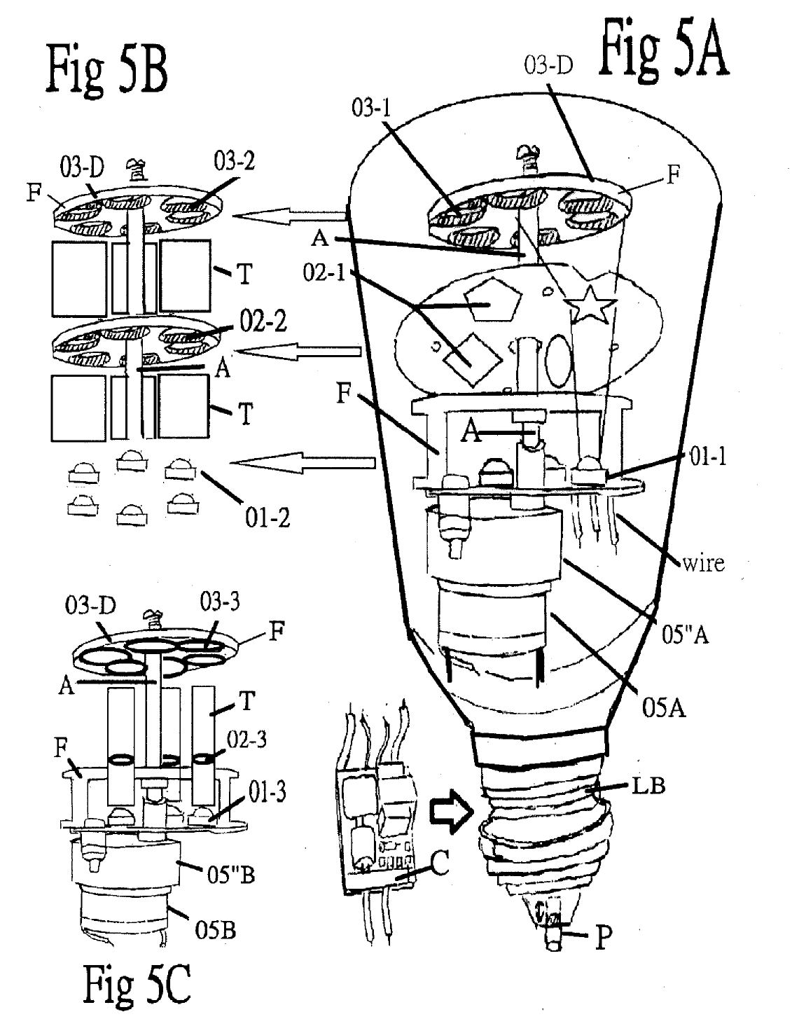

From 1E; Disclosure the FIG. 1C for details construction which has the magnetic & magnetic coil sets to make the magnetic reaction force to pull and push the swing-arm's built-in magnetic unit so can move the swing-arms swinging to make the image-carrier to moving back-and-forth to simulate the sea wave moving effects. The LED light beam pass through the said sea-wave texture image-carrier and emit the tiny image to the top project-lens to magnify to project to wider viewing angle project image on the desire surfaces including wall, ceiling, floor. The moving device here is by magnetic reaction force not from the motor/movement/rotate or spin devices.

FIG. 3 and FIG. 3A and FIG. 3B and FIG. 3C and FIG. 3D and FIG. 3E and FIG. 3F: Disclosure the other embodiment of the said LED bulb apply for down light, or entrance light, stair light, recess light applications such as FIG. 3A, FIG. 3B, FIG. 3C for normal down light installations. Some of other LED Bulb which may has the block-means from the ceiling, walls, lamp shade which made of cement, concrete, metal, porcelain, pottery or any material which will block out the electric wave, electric signal to transmit though to affect or interfere the LED Bulb operated by Wifi, Blue-tooth, internet, App software electric signal delivery so the current invention has different design (FIG. 3F, FIG. 3E, FIG. 3D) has moveable-means such as retractable, extendable, spin, rotate, moving arms, snake house, hinge to move the LED Bulb's at least one level(s) away from (a) Heat (b) light traveling (c) electric signal transmitting (d) all other block-means related to the said LED.

FIG. 4 and FIG. 4A, FIG. 4B disclosure the current invention co-pending filing (# ZZZ-1) U.S. application Ser. No. 14/323,318 which is Continue In Part filing of (# ZZZ-13) U.S. application Ser. No. 14/023,889 both is related to the wider area image or project image night light with motor/spin/rotating kits to project moving big image.

FIG. 5A and FIG. 5B and FIG. 5C disclosure the preferred 5^{th} embodiment which has the basic 3 main construction of the LED(s), image carrier(s), project-lens assembly as all co-pending filing related to one or more than one project filing cases. The current invention had motor/movement means to drive axis to rotating and top of the motor has plurality of LED(s) as light source, the LED light beam go through the image-carriers which has one or more than one film/slide/openings/printed windows with or without the holder or disc which is not rotatable or moving. The lighted tiny image from the said image carrier emit to the top project-lens assembly which may be one or more than one which is moving, rotate, spin to allow the tiny-image light beam to fall within the each project-lens from one edge to other edge to form the big project image moving on top ceiling or walls or floor from angle N to N−1. The normally the angle depend on how many project-lens inside a round disc or round carrier or round holder. Such as 6 lens arranged on the disc as FIG. 5A, the each project-lens around 60 degree, the moving big project image also will show on the surface will has around same 60 degree from appear to dis-appear. This embodiment all parts all fit within the said LED bulb housing parts not as the co-inventor's earlier filing cases the LED, film/slide/displayer/screen, project-lens incorporate with tube or tube-assembly piece. The current invention mainly to fit within the LED bulb housing parts only.

From FIG. 5B disclosure the alternative arrangement for the rotating multiple project-lens assembly which has a round holder to hold or fix the 6 project-lens each from edge to edge of lens around 60 degree or less so the big project image will move from appear to dis-appear around 60 degree on surface. The difference than the FIG. 5A is the light beam from LED(s) and tiny-image light-beams has the relatively and separate tube(s) to position with each LED(s) and Light output end of lighted tiny-image ends, so the light beams from these 2 sections will not leakage too much to inside of the said housing.

From FIG. 6: Disclosure the light theory for the more than one project head same as the co-pending filing that the one project night light or LED bulb has built-in multiple project-assembly like the co-inventor's U.S. Pat. No. 8,083,377 issued date Dec. 27, 2011 FIG. 15 and FIG. 16 has the multiple project head to create multiple big project images on areas or surface. The current invention has plurality of the LEDs and top has image-carrier in one piece or many different film/slide/openings/printed windows/stencils/to allow the LED light beam to pass through for form a lighted tiny-image to go through the top project-lens from number 1 to number N (N-can be same number of top project-lens of the disc or Holder) and from edge to other edge so can see the moving big project image from angle N-appear to Angle N-dis-appear. The construction for example but not limited for these limited drawings. It is appreciated all kind of alternative or replaceable or equal function or result or effects still fall within the current invention scope and claims.

FIGS. 7-9 are schematic diagrams illustrating optics principles utilized by the present invention.

The current inventions all drawing are same as above listed co-inventor co-pending or patent drawing with some change on the LED night light or LED bulb including but not limited to has more than one level(s) and use more than one movable-means can make the at least one level's parts or accessories to any desire location, position and orientation. Also, Each level(s) can has one or more than one functions selected from market available LED or LED(s) light effects, function, performance. So it is easily to refer all these concept is same but belong to brand new while become the LED night light or LED bulb applications with all co-pending filing cases' features and concept. It is appreciated all listed co-pending or patented drawing, concept, feature or equivalent or same functions parts/accessories/electric circuit/concept still fall within the current invention for LED night light or-and LED BULB application.

### DETAIL DESCRIPTION

From the above background and drawing discussion, The current invention for LED night light or LED Bulb can present a continue moving big projection image to move within certain degree from appear to dis-appear for angle or-and present multiple big project image on the surface at the same time.

The current invention co-pending filing cases already made a big improvement than conventional market available all kind of LED night light or-and LED bulb which only can offer near-by areas illumination not like the current invention NOT ONLY has more than one levels, parts, accessories can change position by moveable-means to make the inventor's LED night light or-and LED Bulb can overcome all kind of block-means which may happened by (a) heat created by LED(s) or its circuit, electric components (b) light beam block means to affect or interfere light traveling (c) signal block means to affect or interfere all kind of electric signal transmitting (d) other block means to destroy the said LED desire functions, performance, effects BUT ALSO inventor's LED night light or-and LED bulb can use one LED night light or-and LED bulb to offer near-by and far-away illumination or image or both and the said night light or LED bulb also can has other features such as (1) Multiple colors with changeable colors and moving effects (2) Multiple functions select from market available any LED light effects for indoor and outdoor lighting (3) Multiple control means which select from market available control, sensor, switch, blue-tooth, wifi, internet, app software, remote, infra-red or other electric or electronic related circuit or device(s) (4) More than one movable-means (5) Changeable geometric shape (6) Changeable construction (7) moveable means select from any group combination from bar, pole, spin, rotate, hinge, arms, joints, join, frame, connector, sections to make the levels, parts, accessories to be move away to desire location, positions. These are the main features of the current invention.

The co-pending filing cases already made said LED Bulb has more than one level(s) and has desire level(s) can change position, location, orientation to overcome any block-means to get the desire LED Bulb functions by variety type of moveable-means.

Also, The current invention co-pending filing cases already has more than one light beam emit out from LED bulb which under more than one control means for the one of the light beam may selected from power failure, remote control, Infra red controller, blue-tooth with mobile phone, Wifi, internet control, app software control, motion sensor to trigger at least one of the light beam to offer the light beam for illumination or image to area(s).

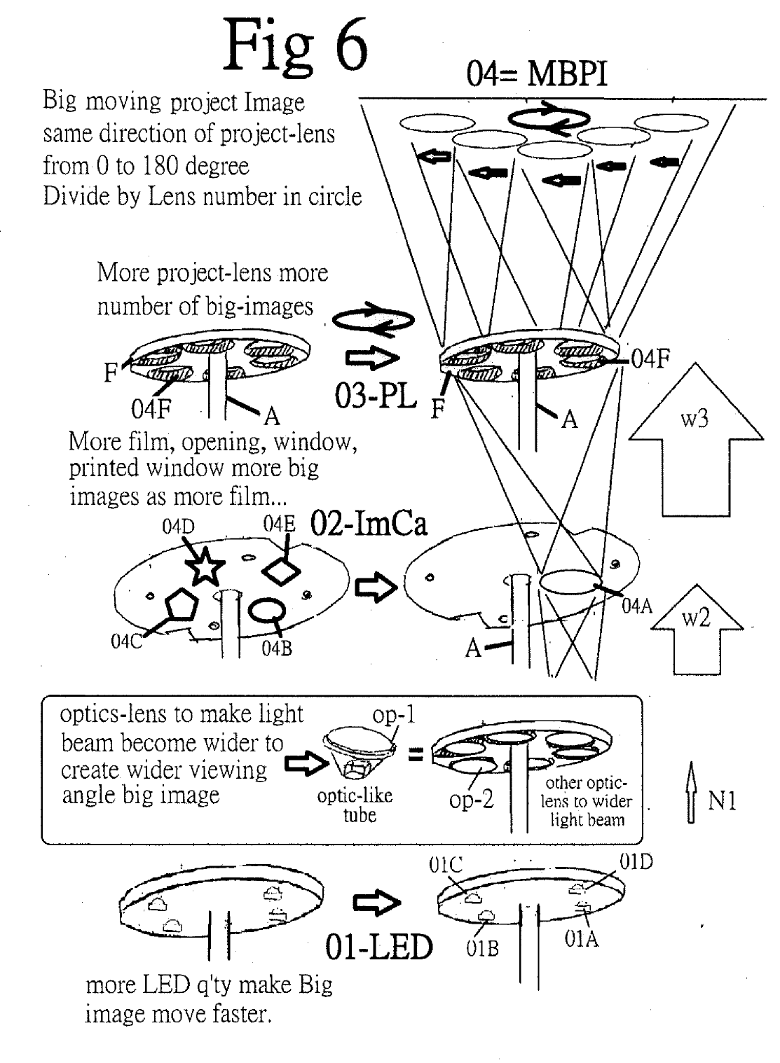

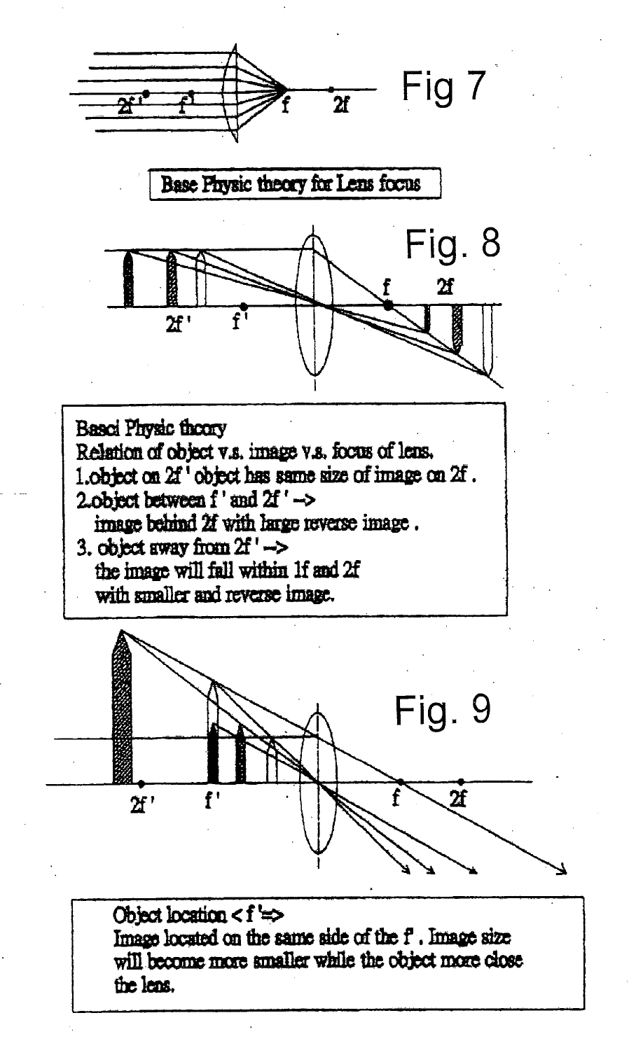

Also, the co-pending filing cases also has other (16) features as below listed:
Features 1: The LED bulb has consist of:
At least one LED(s) as light source of said LED bulb which emit light beam to desire areas, locations with predetermined illumination, function, time period, performance.
The said LED bulb has parts or accessories for desire group combination select from optic means, lens, adjustable focus means, twisted means, rotate means, elastic contact end, more than one output light beam(s), rotating frame, bulb shade with arms for rotating/tile, more twist bulb base, support for shade, LED assembly, LED tubular means, adjust means, project means, digital data display means, Lcos display means, LCD display means, digital camera means, data storage means, data been projected by optics means, sensor means, switch means, IC means, circuit means, extend means, extractable means, filter means, stencil means, cutout means, painting means, motion sensor means, Remote control means, blue tooth means, Internet wireless means to make the said LED bulb emit the light beams, image, time, data, digital message, internet data(s) to desire near-by area(s) or remote-away distance area(s) for illumination.
The said LED bulb connect with power source by contact means of base in preferred construction and configuration and incorporate with electric parts & accessories to emit the light beam(s) to areas with adjustable angle cover preferred in x-y-z axis or any combination as required for preferred light performance, effects, functions.
The improvement including:
At one of the output light beam(s) from the said LED bulb can adjust direction to certain area(s), location(s), distance(s) while adjust above listed component(s) of said LED bulb.
The said base of LED bulb is mail insert means to fit into the female receiving means for desired construction.
The said LED Bulb at least has adjustable parts to make the said at least one of light beam can change position, direction, orientation.
Features 2: The LED Bulb as above listed (Feature #1), the said elastic contact means which allow the said LED bulb can adjust the said at least one of the light beam can be position, location, direction to certain area(s) in x-y-z axis.
Features 3: The LED Bulb as above listed (Feature #1), the said extendable, extractable means which is The parts can be extend away from the said LED Bulb and has certain configuration and construction to allow install some electric parts & accessories, sensor means, motion sensor means, remote control means, heat sensitive means within so can over come heat, light's shade, light's lens, light's curtain, light's glass, light's cover, cavity's depth, or any other block means.
Features 4: The LED Bulb as above listed (Feature #1), the said same light beam can incorporate with Optics means, optics lens, optics lens assembly with parts & accessories to make the same light beam has different light performance.
Features 5: The LED Bulb as above listed (Feature #1), the focus adjust means can make same light beam to present different light performance on the certain location, position, area for desire brightness, size, performance.
Features 6: The LED Bulb as above listed (Feature #1), the said Bulb's frame, support means which offer the Bulb can be twist, tilt, rotate, spin, adjust angle and with hold means to overcome any heat issues to make the said change desired angle.
Features 7: The LED Bulb as above listed (Feature #1), the said Base of LED bulb can be in any construction including screw type, pins type, poles type, multiple poles type, twist type, bayont type, conventional market type for current invention.
Features 8: The LED Bulb as above listed (Feature #1), the said More than one light beam output(s) which means the said LED bulb has more than one of the light beam(s) are emit to the location(s), area(s), position(s) which is remote-away from the said LED Bulb.
Features 9: The LED Bulb as above listed (Feature #1), the said LED assembly, LED tubular means, Project means the construction, parts & accessories which for LED light source so can make the certain LED(s) light beam do not leakage out and passing though the said optics means, optics lens, display unit, image, LCD display image, Lcos image, digital display can be emit out of said LED Bulb to get light beam or image to desire location, position, areas.
Features 10: The LED Bulb as above listed (Feature #1), the said sensor means, switch means, motion sensor means, remote control means, blue tooth means, photo sensor means or other market available electric parts & accessories incorporate the circuit means to make the said LED light source to emit light under predetermined light function, performance, effects.
Features 11: The LED Bulb as above listed (Feature #1), the said extend means, retractable means can install the select electric parts & accessories, also the LED light source depend on the LED bulb application including up or down or horizon arrangement.
Features 12: The LED Bulb as above listed (Feature #1), the said LED Bulb can illuminate the areas including any combination of areas(s) which are near-by area(s), far-away area(s) or together for both near-by and far-away area(s) effects.
Features 13: The LED Bulb as above listed (Feature #1), the said LED bulb has more than one functions not only offer the illumination for near-by area or remote-away distance area(s) but also may incorporate with motion sensor, remote control, blue-tooth for other functions.
Features 14: The LED bulb consist of;
At least one LED bulb which has at least one LED(s) as light source to offer the illumination or image while the light source are connect with related circuit means, IC means, electric parts & accessories and related switch means, sensor means, remote control means, blue-tooth means or equivalent trigger means.
The said LED Bulb has extend means to install the electric parts & accessories, extra LED, sensor means, control means, RF receiving means, IR sensor means, or other equivalent control means to overcome the LED(s) heat, or surrounding block-means of lighting fixture's shade, cover, glass, frame, support, ceiling, wood piece, metal piece, plastic pieces.
The said extend means can extend to certain distance to away from LED(s) heat or any block-means to allow the light beams or electric signal delivery direction without interfere by surrounding heat and block-means to let said LED bulb can has pre-determined function(s), Performance(s), Effects(s).
Feature 15: The LED bulb consist of:
At least one LED bulb which has at least one LED(s) as light source to offer the illumination or image while the light source are connect with related circuit means, IC means, electric parts & accessories and related switch means, sensor means, remote control means, blue-tooth means or equivalent trigger means.
The said LED bulb supply the illumination or image to a remote-away areas(s) by angle, position, orientation, direction, focus adjust means while incorporated with optics means, optics lens, project assembly, LED(s) assembly.
The said LED bulb emit the light beam to desire area(s) in preferred combination of near-by illumination, far-away illumination, near-by image, far-away image, digital data image, movie image, internet digital data image, time display, motion picture image, colorful image.
Feature 16: The LED bulb consist of;
At least one LED bulb which has at least one LED(s) as light source to offer the illumination or image while the light source are connect with related circuit means, IC means, electric parts & accessories and related switch means, sensor means, remote control means, blue-tooth means or equivalent trigger means.
The said LED Bulb has more than one of light beam emit out from the said LED bulb for illumination or image.
At least one of the LED light beam are triggered by control means which may select from group combinations from motion sensor, remote control, Infra red sensor, Bluetooth means, power failure means & build in Direct current power storage means, sensor means, switch means, or other electric parts & accessories means.
The current invention has very details notes on each drawing so here do not discuss details, please refer to attached drawing with brief description below:
FIG. 1 and FIG. 2: Disclosure the 1^{st} embodiment of the said project image main construction for LED night light or LED Bulb has LED light source(s) (01), image carrier(s) (02), project-lens(s) or project-lens assembly (03) to form the big project image (not shown) on desired location and emit out from the said LED night light or LED bulb. All the current invention or the co-pending applications of the said projection LED light all still use the optic theory of the FIG. 7 and FIG. 8 and FIG. 9 only different for the three main projection theory 3 major parts LED light source(s) (01), image carrier(s) (02), project-lens(s) or project-lens assembly (03) put on different location, has different construction, arranged fit on tube or housing parts, incorporated with IC or desired circuit, has motor/movement/spin/rotating device to make the said 3 major parts to change position, or has track, groove, ditch to make the manual or automatically adjust the optic-lens to adjust the focus, has moving parts to allow adjust the project image angle or other features listed or discussed inside of all co-inventor's earlier applications cases.
From FIG. 1 the said Movement (05) which is super silent noisy device which has axis (06) has elongate length to install the LEDs (01) its base circuit board which connect with the PCB (04′) which has the electric parts & accessories to control the LEDs to has desired function including chasing, random, pair flash, sequential, random flash, fade-in and fade-out or any LEDs light function available from market place. The LEDs position with the top position-board (08) which has walls can fit with the preferred or optional other optic-lens which main purpose is to make the each LED's narrow LED light beam to become wider viewing angle LED light beam so can cover to the as wider as possible wider range light beam can emit to the said image carrier (02) so can get shaped light beams to pass through the opening(s), printed window(s), cutout(s), films, slides on the said image carrier (02). The shaped or tiny image light beam out from the said image carrier will emit to the said top project-lens or project-lens-assembly (03) which can be a single project lens (03′) or plurality of the optics-lens from into one assembly (03). The project-lens or project-lens-assembly (03) has at least one optic properties is the refraction the shaped or tiny-image light beam to wider viewing angle image has the desired brightness, color, image, shape, moving. The said big or wider viewing angle project-image (not shown) show on the certain distance away from the said LED night light or from the same construction put inside different outside housing such as into a LED bulb shape and connect with the power source from the LED bulb's base which may be a update retractable contact point allow people to twist one more or more circles to let the can have desired position or orientation.
From FIG. 1, the Axis (06) of the movement (05) extend to top and install LEDs (01) and circuit board and top position board (08) with wall to install the optic-lens (09) and all these parts including LEDs (01), circuit board, top position board (08), optics-lens (09) all is not rotating for this embodiment. Only the image-carrier (02) is moving, rotating, spin with the said movement (05) axis (06) and speed can be design as wish. The moving image carrier (02) will allow the below LED(s) (01) light beam to pass through the different portion of the said image carrier (02) and the shaped or tiny-image light beam will be come out from the openings, cutouts, film, slide, printed windows to emit to the top plurality of optics-lens-assembly's (03) big viewing angle from more than 90 degree to 270 degree project-lens so can project a super big size of the project-image on the desired surface including ceiling, walls, floor to show out moving effects or the said shaped or tiny-image light beam out of the said image-carrier. The said FIG. 1 shaped or tiny-image light beams while pass through the top plurality of optic-lens assembly project-lens which will be refracted the all shaped light beam to random directions with different shaped light patterns while the image carrier has shape openings or cutout or printed windows not film or slide so it look like the aurora effects with moving effects which are created by the moving image-carrier one of the application not limited to for other or alternative or equal construction to make the image-carrier to be rotated, spin, moving.
From FIG. 2 very similar with the FIG. 1 but the rotating or moving unit is the said Top Project-lens or project-lens-assembly (03′) not the said Image carrier (02′). The different arrangement or rotating unit from the image carrier (02) to change to project-lens or project-lens-assembly (03′) will form the different light effects. To rotating the project-lens or project-lens-assembly (03′) will get the shaped or tiny-image out for the image-carrier to pass through the top each single optic-lens of the multiple optic-lens assembly so can get one by one image on the different location and look like continue image moving for certain degree such as 6 optics-lens assembly can get around 60 degree moving image. This has details design description on the FIG. 6. Same as FIG. 1, the FIG. 2 embodiment has the 3 major components for LEDs (01′) and Image-carrier (02′) and Project-lens-assembly (03′) all fit along with the below motor (05′) and motor gear set (05″). The motor has very faster rotate cycles per minutes (RPM) so need one motor gear set (05″) to reduce to preferred RPM so people will not see too quickly rotating or moving project-image feel bad. The LEDs (01′) fit on the circuit board and LED(s) light beam emit through the optional position board (08′) or other design frame (F), support (S), holder (H) or has the other optics-lens (not shown) to make the narrow LEDs light beam to become wider viewing angle LED light beam and pass though the said the top of the LEDs position board (08′) has the image carrier (02′) which same as the FIG. 1 has the preferred shaped openings, cutouts, stencils, film, slide, display-unit so can allow the LEDs light beam to pass and emit the said shaped or tiny-image light beam to the said each single project-lens (03″) to form the image and because the each single project-lens (03″) is rotating so the shaped or tiny-image light beam will go though one by one of the single optics-lens (03″) to form the image on different timing and angle so can form a continue same big project-image shown on the surface.
From FIG. 2, to rotate the said project-lens or project-lens-assembly (03′) which has number of the single optic-lens (03″) and while the shaped or tiny-image light beam has sufficient wider angle so can passing through the many of the said the single optic-lens (03″) because optics-lens is rotating so the image will be same and the look like same image continue show up and moving from one circle side to other circle side. The moving direction can be clockwise or anti-clockwise which depend on the below motor or movement or spin device rotation direction. The number of the shape or opening or cutout or printed window or film or slide or the display-unit and its related LED number to form the lighted shape or tiny-image light beam also will get the number of big project-image.
More detail for the moving Project-lens or project-lens-assembly (03) for lighting effects shown on the FIG. 6 with more details.
From FIG. 1A show the co-pending filing case with the alternative way to create a wider viewing angle project-image on the surface. This embodiment use more than one optic-lens has at least one is refractive lens to make the LEDs light beams to pass though the 1^{st} lens to get narrow LEDs light beam to become many of refraction light beams and the said many refraction light beams go through the outside 2^{nd} lens to make the more wider viewing angle project-images. The said 1^{st} lens may also has texture which can be a wave type and the LEDs can be more than one of Blue-light and Green-light or white-light LEDs with IC controller to make the said LEDs color changing on desired time period with desired functions and speed and brightness may select but not limited for fade-in and fade-out, chasing, pair-flashing, random, automatically changing function, freeze function, sequential or other market available LED light functions still fall within the current invention's scope.
The FIG. 1A, the blue, blue, blue color 3 LED light beam emit to the wave texture optical lens which is has received all the LEDs light beam and go through the Wave texture refraction optic lens so came out many of the light beam and pass though the 2^{nd} lens then can come out a lot of wave shaped blue, green, white project image. While the blue, green white LEDs are turn on and turn off on different time period and from 1^{st} Blue→2^{nd} Blue→3^{rd} blue with preferred fade-in and fade-out sequential, and LEDs arrangement with 1->2->3 front and back, then, can create the moving water wave effects so this is use non-motor device to make a big viewing angle moving project-image is the one of the current and co-invention application features and should be fall within the current invention for moving project-image scope.
From FIG. 1B and FIG. 1D which FIG. 1B show the outside shape and FIG. 1D show the details construction how to make the moving project-image like the said Aurora as the said preferred embodiment of FIG. 1. The said FIG. 1 has the top wide angle around 180 degree project-lens which are formed by plurality of small optic-lens like FIG. 1 and each small optic-lens has its focus and thickness and curvature of the lens so can make the different reflective, refractive light effects.
The said inner construction as the above discussed FIG. 1, the main 3 components LEDs, image-carrier, project-lens-assembly as above discussion. The current invention and all the FIG. 1A, FIG. 1B, FIG. 1C, FIG. 1D, FIG. 1E has prongs to become a big viewing angle projection night light while the same construction of the major 3 components fit into the Bulb shape housing with bulb-base can instantly become the LED Bulb has the moving project-image LED bulb. The power source come from wall outlet or from the bulb-base power source just through the different conductive prong or conductive bulb base. So all the current invention cover for LED plug-in night light or the LED bulb with conductive bulb base for all kind specification should be still fall within the current invention. So all the preferred embodiment has prong is equal has the bulb base. The housing can be any geometric shape.
From FIG. 1C and FIG. 1D is outside shape and details construction show the other alternative way to get the moving project-image for LED night light or the LED bulb. Again, this is same as Co-pending filing case (#ZZZ-3) U.S. application Ser. No. 14/503,647 which apply the same 3 major components LEDs (01″), image-carrier (02″), and Project-lens assembly (03″) to form the big viewing angle project-image by electric magnetic force to pull or push the vibration, shaking, swing, waving, moving part (02B), arm (02B), pole (02B), craft (02B), axis (02B), bar (02B), pole (02B) connect with magnetic unit (02A) which will be affect or reaction to the said magnetic-coil device (02E) while the different current passing through the said magnetic-coil (02E) to create magnetic field and force to pull or push the magnetic-unit (02A) for close or pull away. So the magnetic-unit will bring the attached, connected, joint-together said moving part (02B), arms (02B), pole (02B), craft (02B), axis (02B), bar (02B), pole (02B) to be waving, shaking, swing, moving to make the 1^{st} optic lens or image-carrier (02″) has texture or without texture to be change position to make the said desired light effects. The said Moving parts (02B) is attached on the 1^{st} optic-lens or image carrier (02″) two sides pole (02C) while the moving parts (02B) is moving and the two sides pole (02C) sit on the two side frame (02D) will be also change position so make the said 1^{st} optic-lens or image-carrier (02″) moving so make the image carrier 1^{st} optics-lens to emit the different light beam to the top project-lens and form the big viewing angle project image on the desired floor, ceiling or walls but not shown on the wall where has the outlet or surface has the bulb base.
From FIG. 3, FIG. 3A, FIG. 3B, FIG. 3C, FIG. 3D, FIG. 3E, FIG. 3F show the co-pending filing all kind of preferred LED bulb designs and shape. The inner may has the desired moving optics-lens, moving image-carrier, different LED turn on and turn off time, magnetic reaction force device, or single project tube device, or multiple single project tube device, or project assembly inside these housing to get the wide viewing angle moving project-image show on the surface.
From FIG. 4 and FIG. 4A, FIG. 4B disclosure the Co-pending Filing (#ZZZ-12) U.S. application Ser. No. 14/323,318 (# ZZZ-1) and Ser. No. 14/023,889 (# ZZZ-12) those drawing show the 1^{st} embodiment to use the said motor (05-4A) to drive the axis (A) to rotating the top project-lens which has multiple refraction or-and reflection lens to allow the inner LEDs (01-4) (01-4B) to passing though the multiple reflective or-and refractive lens to spread out the different turn on and turn off LED color light beam to wide viewing angle for moving project-image. The each color of the said LEDs (01-4) and (01-4B) can be different color and turn on and turn off controlled by IC so can had all kind of light effects including chasing, random, pair flash, fade-in and fade out, sequential, color changing, freeze function, auto changing function, 7 function in 1 or any other available function from market place.
The FIG. 4, FIG. 4A, FIG. 4B also has circuit (C-4) (C-4A) (C-4B0 and motor's gear set (05′-4) (05′-4A) (05″-4B) so can get desired rotating speed of axis (A) to drive the top multiple reflective or-and refractive dome lens can rotating under predetermined speed to make people enjoy the moving and changeable color, function light effects from the said current invention for LED Night Light or LED Bub while the same construction fit into the plug-in Night light or fit into the said Bulb shape with the bulb base to get the Power source.
From FIG. 5A disclosure the Same construction with the FIG. 2 which has the Moving or Rotating optic-lens-assembly (03D) which has the 6 of the single optic-lens (03-1) which can project the shaped or tiny-image light beam through the refractive lens (03-1) to become big project-image shown on the desire surface. The current invention has the 6 single optical-lens arrange within a frame (F) for 360 degree so each single optic-lens (03-1) almost cover the 60 degree of the said frame (F). So the wide viewing angle project-image will moving also around 60 degree for circle range while the top project-lens-assembly each single project lens take 60 degree, then the big project image traveling will be around 60 degree. The said LEDs (01-1) has narrow viewing angle so may has optional Optic-lens added like FIG. 5B (02-2) to let the narrow light beam become wider viewing angle light beams or add the distance from the LED top to the image-carries but it will loose some light brightness. While the LEDs light beam emit to top the said image carrier (02-1) through the image carrier's (02-1) openings, printed windows, stencils, cutouts, films, slide, display-units or changeable image or display, the said lighted shaped or tiny-image light beam will emit to top single optical-lens (03-1) fixed on the said frame (F) of the said projection-lens-assembly (03D). The wider viewing angle the said shaped or tiny-image light beam go through the said each single optics-lens (03-1) and form the image because all the optic-lens (03-1) is rotating one by one so the each single optic-lens image will look like a continue one image to moving from circle one side to other side for certain degree depend on the each single optic-lens (03-1) occupy how many angle of the said frame (F).
The FIG. 5A, the image carrier (02-1) has 4 shaped opening, holes, cutout, printed windows, film, slide, display-unit, changeable display windows so can project 4 different images if had relatively LED for the said 4 different tiny-images that is openings, holes, cutout, printed windows, film, slide, display-unit, changeable display windows to create the 4 big project-image and rotating on all same direction or desired directions.
From FIG. 5A the LED (01-1), Image carrier (02-1), project lens assembly (03-1) and single optics-lens (03-1) and motor (05A) and Gear set (05″-1) all fix along the axis (A) with desire frame (F) or fix on the housing parts (not shown) so whenever the outside housing changed the current invention can be for LED night light or LED bulb and each had its prong or Bulb base to get the AC power.
From the FIG. 5B same as the all co-inventor and co-pending LED project light has the same LEDs (01-2) and image-carrier (02-2) and Project-lens assembly (03-2) with single optic-lens (03D) and only the said project-lens-assembly is rotting along the axis (A) with tube or tube assembly to install the said other optional optic-lens to wider the narrow LEDs light beam and also use the tube or tube-assembly to prevent from the light beam leakage so can concentrate all LED wide light beam to cover as many as single optic-lens. Or/The Tube or tube-assembly it is a optic-lens to make the narrow LED light become wider and also can prevent from the light leakage through the wall of the said Optic-like Tube or tube-assembly. This depend on the market requirements so this FIG. 5B is for just concept for optic-like tube means which can be in any shape such as wider top and narrow end type of optic-like tube or tube-assembly (Not shown).
From FIG. 5C show the alternative way the image-carrier is a film or slide which fit into the optic-like tube or tube-assembly which may straight or wider-top-narrow-base optical-tube which has reflective material coated outside so no light can leakage to outside and LEDs may also into the one end of the optic-like tube or tube-assembly so even the film or slide is install within the optic-like tube inside by groove, holder, ring. So the wider shaped or tiny-image light beam emit to top rotating single optic-lens (03-3) and create moving rotating certain degree multiple big projection image such as STARWAR characters, Frozen character or any Disney Characters or cartoon, time, logo, art work . . . etc.
From FIG. 6 show the 3 main components LEDs (01-LED), image carrier (02-ImCa), project-lens-assembly (03-PL) to make the wider viewing angle big moving project image. The said LEDs (01-LED) has its relatively top image carrier (02-ImCa) so can has the shaped or tiny-image light beams to emit to the project-lens-assembly (03-PL) each single project-lens to get the continuously moving clear and big project-image to travel certain degree of the circle with wide viewing angle to viewer.
The LEDs (01-LED) has narrow light beam as right hand side of FIG. 6 for narrow light beam (N1) through the other optic-lens (OP-1) or optics-like tube (OP-1) can become wider (W2) and passing through the image carrier (02-ImCa) with some distance to get the More wider (W3) shaped or tiny-image light beam to emit to project-lens-assembly (03-PL) to form the continuously moving big project-image (04-MBPI). The more LEDs (01A, 01B, 01C, 01D) and its image-carrier (04A) can get more moving big project image. The moving big project image (04-MBPI) the moving direction for clock-wise or anti-clock wise will be depend on the motor and its gear-set direction. The moving big projection image (04-MBPI) moving angle will depend on the number of single optics-lens (04E) number within the 360 degree of holder or frame. More single optics-lens (04E) will has less traveling angle of the said moving big project image (04-MBPI). For the FIG. 6, the 6 single optic-lens (04E) within the 360 degree frame or holder, the moving big project-image (04-MBPI) will travel around 360/6=60 degree. So more single optic-lens (o4E) inside of the frame (F) will get less travel angle. Also, the less openings (04B), cutouts (04C), printed windows (04D), film (04B), slides (04E) will get less type/design/shape/image of the moving big project-image (04-MBPI). Also, If only had one top single optic-lens with one printed-window, the one continue moving big project image (04-MBPI) will move very slow because the axis rotate 360 degree only had one single optic-lens can project image for around 180 degree. So the moving big project image (04-MBPI)
FIG. 1A and FIG. 1B and FIG. 1C: Disclosure the 3 embodiment of the said project night light has the wider viewing angle moving project image from the said 3 different moving theory night light. FIG. 1A is use LEDs on time on different time period to change the Light source relative position, orientation to the said image carrier or-and project-lens(s). FIG. 2A is used motor or movement, spin, rotate, moving device to make the said image carrier(s) to moving to make the big project image to moving. FIG. 3A use the magnetic & magnetic-coil with mechanical arms to make the image carrier to moving, shaking, swing to make the said big project image moved.
FIG. 1BB: Disclosure the FIG. 1B for details construction which has movement or motor on bottom with axis long enough to hold and rotate the said image carrier and also allow the LEDs and circuit board along the axis so can allow LED(s) light beam passing through the top optic-lens (change narrow LED light beam to wider and parallel light beam) to hit the top image-carrier and light passing through the image-carrier's opening, cutout, windows, printed window, film, slide, or display or digital data display and go through the top project-lens which may in variety type including but not limited for one refraction-lens or multiple refraction-lens or refraction with reflection lens or any combinations from market available type to create desired light effects. (This drawing same as co-pending filing (# ZZZ-3) U.S. application Ser. No. 14/503,647),
From 1CC; Disclosure the FIG. 1C for details construction which has the magnetic & magnetic coil sets to make the magnetic reaction force to pull and push the swing-arm's built-in magnetic unit so can move the swing-arms swinging to make the image-carrier to moving back-and-forth to simulate the sea wave moving effects. The LED light beam pass through the said sea-wave texture image-carrier and emit the tiny image to the top project-lens to magnify to project to wider viewing angle project image on the desire surfaces including wall, ceiling, floor. The moving device here is by magnetic reaction force not from the motor/movement/rotate or spin devices.
FIG. 3A and FIG. 3B and FIG. 3C and FIG. 3D and FIG. 3E and FIG. 3F: Disclosure the other embodiment of the said LED bulb apply for down light, or entrance light, stair light, recess light applications such as FIG. 3A, FIG. 3B, FIG. 3C for normal down light installations. Some of other LED Bulb which may has the block-means from the ceiling, walls, lamp shade which made of cement, concrete, metal, porcelain, pottery or any material which will block out the electric wave, electric signal to transmit though to affect or interfere the LED Bulb operated by Wifi, Blue-tooth, internet, App software electric signal delivery so the current invention has different design (FIG. 3F, FIG. 3E, FIG. 3D) has moveable-means such as retractable, extendable, spin, rotate, moving arms, snake house, hinge to move the LED Bulb's at least one level(s) away from (a) Heat (b) light traveling (c) electric signal transmitting (d) all other block-means related to the said LED.
FIG. 4 and FIG. 4a, FIG. 4b disclosure the current invention co-pending filing (# ZZZ-1) U.S. application Ser. No. 14/323,318 which is Continue In Part filing of (# ZZZ-13) U.S. application Ser. No. 14/023,889 both is related to the wider area image or project image night light with motor/spin/rotating kits to project moving big image.
FIG. 5a and FIG. 5b and FIG. 5c and FIG. 5d disclosure the preferred 5^{th} embodiment which has the basic 3 main construction of the LED(s), image carrier(s), project-lens assembly as all co-pending filing related to one or more than one project filing cases. The current invention had motor/movement means to drive axis to rotating and top of the motor has plurality of LED(s) as light source, the LED light beam go through the image-carriers which has one or more than one film/slide/openings/printed windows with or without the holder or disc which is not rotatable or moving. The lighted tiny image from the said image carrier emit to the top project-lens assembly which may be one or more than one which is moving, rotate, spin to allow the tiny-image light beam to fall within the each project-lens from one edge to other edge to form the big project image moving on top ceiling or walls or floor from angle N to N−1. The normally the angle depend on how many project-lens inside a round disc or round carrier or round holder. Such as 6 lens arranged on the disc as FIG. 5A, the each project-lens around 60 degree, the moving big project image also will show on the surface will has around same 60 degree from appear to dis-appear. This embodiment all parts all fit within the said LED bulb housing parts not as the co-inventor's earlier filing cases the LED, film/slide/displayer/screen, project-lens incorporate with tube or tube-assembly piece. The current invention mainly to fit within the LED bulb housing parts only.
From FIG. 5B disclosure the alternative arrangement for the rotating multiple project-lens assembly which has a round holder to hold or fix the 6 project-lens each from edge to edge of lens around 60 degree or less so the big project image will move from appear to dis-appear around 60 degree on surface. The difference than the FIG. 5A is the light beam from LED(s) and tiny-image light-beams has the relatively and separate tube(s) to position with each LED(s) and Light output end of lighted tiny-image ends, so the light beams from these 2 sections will not leakage too much to inside of the said housing.
From FIG. 6a: Disclosure the light theory for the more than one project head same as the co-pending filing that the one project night light or LED bulb has built-in multiple project-assembly like the co-inventor's U.S. Pat. No. 8,083,377 issued date Dec. 27, 2011 FIG. 15 and FIG. 16 has the multiple project head to create multiple big project images on areas or surface. The current invention has plurality of the LEDs and top has image-carrier in one piece or many different film/slide/openings/printed windows/stencils/to allow the LED light beam to pass through for form a lighted tiny-image to go through the top project-lens from number 1 to number N (N-can be same number of top project-lens of the disc or Holder) and from edge to other edge so can see the moving big project image from angle N-appear to Angle N-dis-appear. The construction for example but not limited for these limited drawings. It is appreciated all kind of alternative or replaceable or equal function or result or effects still fall within the current invention scope and claims.

The current inventions all drawing are same as above listed co-inventor co-pending or patent drawing with some change on the more than one of level LED Bulb and show more details for variety of the moveable-means which can easily find from market available skill or method all fall within the current invention scope not limited for the above disclosure for the arms, snake house, or the movable, rotate, spin, bar, pole . . . etc. So it is easily to refer all these concepts are same but belong to brand new while become the LED bulb applications with all prior arts features and concept. It is appreciated all listed co-pending or patented drawing, concept, feature or equivalent or same functions parts/accessories/electric circuit/concept still fall within the current invention for LED BULB application.

1. A moving project-image assembly consists of
At least one project-assembly has LED(s) incorporated image-carrier and project-lens fit or within the frame, support, housing parts to create wider viewing angle big size project-image on arm away ceiling, walls, floor or desired surface.
At least one of the moving device incorporate with the project-assembly including but not limited from motor, time movement, magnetic-unit & magnetic-coil set, LEDs with IC controller for different time to turn-on and turn-off.
The moving device make the said at least one of the LEDs or-and image-carrier or-and project-lens to moving, rotating, swing, waving, shake, spin, variable, or change to create the said big size project-image has moving, waving, rotating, spin or-and changing position, color, focus, brightness functions.

2. A moving project-image assembly as claim 1, the said LEDs light beam pass through the said image-carrier's printed window(s), film(s), slide(s), opening(s), cut-out(s), stencil(s), display-unit(s) to form shaped or tiny-image light beam to emit to the project-lens and form the wider viewing angle big project-image.

3. A moving project-image assembly as claim 1, the said assembly fit into the said LED plug-in Night light.

4. A moving project-image assembly as claim 1, the said assembly fit into the said LED Bulb.

5. A moving project-image assembly as claim 1, the said motor has gear set to change the high motor rotating RPM to desire Axis RPM to rotate the image-carrier or the project-lens or project-lens assembly.

6. A moving project-image assembly as claim 1, the said movement has desired RPM.t.

7. A moving project-image assembly as claim 1, the said assembly has other optic-lens to wider the narrow LEDs light beam to wider light beam.

8. A moving project-image assembly as claim 1, the said assembly has more than one number or-and more than one color of LEDs.

9. A moving project-image assembly as claim 1, the said project-lens contains or consists of more than one separated single optic-lens which are fit into frame, holder, disc for the said project-lens.

10. A moving project-image assembly as claim 1, the said project-lens has more than one and one-by-one optic-lens combination to form a one big piece of the project-lens that has plurality different refraction rate or properties to from the one big piece of project-lens.

11. A moving project-image assembly as claim 1, the said project-lens rotating by motor, gear set, axis.

12. A moving project-image assembly as claim 1, the said image carrier has at least one of printed window(s), film(s), slide(s), openings, cut-outs, stencils, display-unit.

13. A moving project-image assembly as claim 1, the said moving device to rotate, spin, move, vibrate, shake, wave the said project-lens or-and image carrier to make the big project-image to have moving, waving, spin, move, change position, adjust focus.

14. A moving project-image assembly as claim 1, the said LEDs has IC controller to make LEDs to change color, brightness, on-off time, duration, cycles and offer chasing, random, sequential, fade-in & fade-out, color changing, freeze color, freeze function or other LED light functions.

15. A moving project-image assembly as claim 1, the said other optic-lens including texture or printing or image or refractive function.

16. A moving project-image assembly as claim 1, the said assembly has tube, tube assembly or optic-like tube or top wide-base narrow optic-lens to increase the LEDs light effects.

17. A moving project-image assembly as claim 1, the said big project-image is a cartoon character, time, geometric shape image, logo, word, art work, weather or vision image.

18. A moving project-image assembly as claim 1, the said big moving project-image created by rotating project-lens for a continue moving image move from one side to other side along the arc or circle or curve.

19. A moving project-image assembly as claim 1, the said big moving project-image created by the rotating image-carrier which has shaped openings or cutouts or printed windows and the color changing LEDs light beam pass image-carrier to form same shaped light beam passing through the top multiple different refraction optic-lens act as project-lens to show the wider viewing angle shaped project-image.

20. A moving project-image assembly as claim 1, the said big moving project-image created by IC controlled LEDs for different time to turn-on and turn-off LEDs and said LEDs light beam passing through 1^{st} textured refractive optic-lens act as image-carrier and emit to 2^{nd} big degree round or big size flat optic-lens act as project-lens to form the wider viewing angle moving light effect's project image.

21. A moving project-image assembly as claim 1, the said big moving project-image created by shaking the 1^{st} textured optic-lens act as image-carrier by magnetic-unit reaction with magnetic-coil device to pull or push the said arms, bar, cran-shift, bar, tube to shake the 1^{st} optic-lens so LEDs light beam pass through 1^{st} optic-lens texture and emit to 2^{nd} outside big degree round or big size flat optics-lens act as project-lens to form the wider viewing angle moving light effects.

22. A moving project-image assembly as claim 1, the said big moving project-image created by the moving image-carrier which LEDs light beam pass through the image-carrier's plurality of the printed-windows, cutouts, stencils, film, slide and pass through the big degree or big size flat top refractive project-lens to make the big geometric Project image.

23. A moving project-image assembly as claim 1, the said big moving project-image created by moving device has the cover, outside cover or outer project-lens has big degree of the round or semi-sphere or ball or big flat size optics design lens so can create the big viewing angle project-image on the surface.

24. A moving project-image assembly as claim 1, the said moving project-lens which has plurality of single optic-lens has the outer 2^{nd} cover, dome, top-piece with or without the optics-properties.

25. A moving project-image assembly as claim 1, the said other optics-lens in front of the LED main purpose to change the narrow LED light beam to wider light beam.

26. A moving project-image assembly as claim 1, the said other optics-lens in front of the LED main purpose to make the LED light beam passing through the textured optic-lens to form the desire patterns of the light beam.

27. LED plug-in night light has moving project-image consists;
At least one LEDs and image-carrier and project-lens to create the big project-image on ceiling or walls or floor at arm away from the night light.
At least one motor, movement, magnetic-unit & magnetic coil set to make the said at least one LEDs or-and image-carrier or-and project-lens to move, rotating, spin, shake, wave to make the said big size project-image.
The LEDs connect with power source and circuit to turn on the LEDs under pre-determined light function, effects, performance.
The LED light beam pass through the said image-carrier's openings, film, slide, display-unit to get light beam has shaped or tiny-image and emit to refractive project-lens or project-lens-assembly to create big size moving image.

28. A LED Bulb has moving project-image consists;
At least one LEDs and image-carrier and project-lens to create the big project-image on ceiling or walls or floor at arm away from the night light.
At least one motor, movement, magnetic-unit & magnetic coil set to make the said at least one LEDs or-and image-carrier or-and project-lens to move, rotating, spin, shake, wave to make the said big size project-image.
The LEDs connect with power source and circuit to turn on the LEDs under pre-determined light function, effects, performance.
The LED light beam pass through the said image-carrier's openings, film, slide, display-unit to get light beam has shaped or tiny-image and emit to refractive project-lens or project-lens-assembly to create big size moving image.
